(19) United States
(12) Patent Application Publication
(10) Pub. No.: US 2006/0090842 A1
(43) Pub. Date: May 4, 2006

(54) Joining of thermoplastics with other types of materials

(76) Inventor: Christophe Chervin, Neydens (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/248,804

(22) Filed: Oct. 12, 2005

Related U.S. Application Data
(60) Provisional application No. 60/623,933, filed on Nov. 1, 2004.

(51) Int. Cl. B29C 47/00

(52) U.S. Cl. 156/245

(57) ABSTRACT

Thermoplastics are joined to other types of materials such as metals and ceramics by bonding a sheet with irregular surfaces to the other material and melt bonding the thermoplastic to the sheet having the irregular surfaces. Such sheets include those, which are microporous, or are nonwoven fabrics. The resulting assemblies are useful for a variety of purposes where the combination of a thermoplastics and another material is useful.

### CROSS REFERENCE TO RELATED APPLICATION

This application claims the benefit of U.S. Provisional Application No. 60/623,933, filed Nov. 1, 2004.

### FIELD OF THE INVENTION

The present invention relates to joining materials to thermoplastics. More particularly, the present invention relates to thermoplastics that may be joined to other materials such as metals and ceramics by using an adhesive to adhere one side of a sheet having irregular surfaces to the other material using an adhesive, and adhering the thermoplastic to the other side of the sheet by melt bonding in a mold.

### BACKGROUND OF THE INVENTION

Thermoplastic polymers (TPs) are important items of commerce, many different types (chemical compositions) and blends thereof being produced for a myriad of uses. Sometimes it is desirable to bond together a TP with another type of material such as metal, ceramic, glass, or wood. Although this may be done by a myriad of methods, for instance mechanical fasteners, often the simplest and cheapest method is some sort of bonding process. This often involves use of an adhesive, but many adhesives do not adhere well to both a TP and another type of material. Therefore improved methods of bonding TPs to other types of materials are needed.

The following disclosures may be relevant to various aspects of the present invention and may be briefly summarized as follows:

U.S. Pat. No. 4,892,779 describes a multilayer article formed by fusion bonding a microporous polyolefin layer of a specified composition with a nonporous material such as a TP. No mention is made of using the polyolefin layer material to bond a TP to another type of material using an adhesive.

Nonwoven fabrics (NWFs) have also been used to bond other materials together, such as wood and polyethylene, see for instance U.S. Pat. No. 6,136,732 in which a NWF is impregnated with a powdered adhesive which is then bonded to the NWF by melting the adhesive. This sheet may be used to bond “vinyl and/or cloth covering and a variety of surfaces including metal, plastic, rubber and wood.” by melting the adhesive on the NWF. No mention is made of using melt bonding in a mold.

U.S. Pat. No. 6,544,634 contains an example (Example 19) in which a rubber is “fused” to the surface of a microporous sheet, this assembly is placed into an injection mold with the uncoated side of the microporous sheet exposed, and propylene is injection molded into the mold. This patent does not disclose joining a thermoplastic to another type of material using an adhesive.

German Patent Applications 1,569,324 and 1,569,325 describe the use of a microporous sheet to bond a thermoplastic to another type of material. A thermoplastic sheet is bonded to the microporous sheet in what appears to be a lamination process, and then an adhesive is used to adhere the other material to the other side of the microporous sheet. These applications do not disclose molds or molding.

### SUMMARY OF THE INVENTION

Briefly stated, and in accordance with one aspect of the present invention, there is provided a process, comprising:

(a) using an adhesive, bonding a first surface of a first article to a first side of a sheet having said first side and a second side, wherein said first and second sides have irregular surfaces;

(b) inside a mold melt bonding a thermoplastic to said second side of said sheet;

provided that said first surface of said first article does not comprise a resin; and

producing a second article wherein said first article and said thermoplastic are bonded together.

### DETAILED DESCRIPTION OF THE INVENTION

Definitions:

The following definitions are provided as reference in accordance with how they are used in the context of this specification and the accompanying claims.

“Sheet” means a material shape in which two of the surfaces have at least about twice, more preferably at least about 10 times, the surface areas of any of the other exterior surfaces. Included in this definition would be a sheet with the dimensions 15 cm×15 cm×0.3 cm thick, and a film 15 cm×15 cm×0.2 mm thick. The latter (which is often called a film) in many instances will be flexible and may be drapeable, so that is can be adapted to conform to irregular surfaces. Preferably the sheet has a minimum thickness of about 0.03 mm, more preferably about 0.08 mm, and especially preferably about 0.13 mm. Preferably the sheet has a maximum thickness of about 0.64 mm, more preferably about 0.38 mm, and especially preferably about 0.25 mm. It is to be understood that any preferred minimum thickness can be combined with any preferred maximum thickness to form a preferred thickness range.

“Irregular surface” means that the surface has irregularities in or on it that will aid in mechanically locking to it any molten material, which flows into or onto the surface and the irregularities thereon, and when the molten material subsequently solidifies it causes the material to be mechanically locked (i.e. bonded) to the irregular surface.

“Resin” means any organic polymeric material, whether of natural or manmade (synthetic) origin. Synthetic materials are preferred.

“Irregular surface sheet (ISS)” means a sheet having two “irregular surfaces”.

“Melt bonding” means the TP is melted where “melted” means that a crystalline TP is heated to about or above its highest melting point, while an amorphous thermoplastic is heated above its highest glass transition temperature. While melted the TP is placed in contact with an appropriate surface of the ISS. During this contact, usually some pressure (i.e. force) will be applied to cause the TP to flow onto and often penetrate some of the pores or irregularities on the surface of the ISS. The TP is then allowed to cool, or otherwise become solid.

“Thermoplastic” (TP) is material that is meltable before and while being melt bonded to the ISS, but in their final form are solids, that is they are crystalline or glassy (and therefore typical elastomers, whose melting points and/or glass transition temperature, if any, are below ambient temperature, are not included in TPs, but thermoplastic elastomers are included in TPs). Thus this can mean a typical (i.e. “classical”) TP polymer such as polyethylene. It can also mean a thermosetting polymer before it thermosets (e.g. crosslinks), that is, while it can be melted and flows in the molten state. Thermosetting may take place after the melt bonding has taken place, perhaps in the same apparatus where the melt bonding took place, and perhaps by simply further heating of the thermoset resin, to form a resin which is glassy and/or crystalline. Useful thermoplastic elastomers include block copolyesters with polyether soft segments, styrene-butadiene block copolymers, and thermoplastic polyurethanes.

“Bonded” herein is meant the materials attached to one another, in most instances herein permanently, and/or normally with the ISS and adhesive between the materials.

By an “adhesive” means a material that assists in bonding the ISS to the other material. Adhesives may be in any form, for example melt adhesive, contact adhesive, double-sided adhesive tape, heat activated adhesive, or transfer tape. The adhesive for example may be based on epoxy, polyurethane or acrylic resin, natural and synthetic rubber, and silicone.

By “in a mold” means inside a mostly or completely closed chamber (except for relatively small channels or runners through which TP may be added to the mold or air is allowed to escape from the mold) in which, at some point in time, molten polymer comes in contact with the second side of the ISS. Typically there will be at least some pressure within the mold so that the TP is forced against (into) the ISS surface. Preferred molds are those, which are used in polymer, melt forming operations, such as injection molding, compression molding, compression injection molding, thermoforming, and extrusion or injection blow molding. Preferred molds are those for (and used in) injection molding. These and other types of molds and their molding processes are well known in the art, see for instance S. L. Belcher, Practical Extrusion Blow Molding, Marcel Dekker, New York, 1999; E. L. Buckleitner, Plastics Mold Engineering Handbook, 5^{th} Ed., Chapman & Hall, New York, 1995; H. Rees, Mold Engineering, Hanser Publishers, Munich, 1995; and J. Florian, Practical Thermoforming: Principles and Applications, Marcel Dekker, New York, 1996.

The ISS sheet may have irregular surfaces formed in many ways. It may be: a fabric, for instance woven, knitted or nonwoven; a paper; foamed, particularly an open cell foam and/or an open cell microcellular foam; a sheet with a roughened surface formed by for example sandblasting or with an abrasive such as sandpaper or sharkskin; and a microporous sheet (MPS). Preferred forms of ISS are fabrics, especially nonwoven fabrics (NWFs), and microporous sheets (MPSs).

“Microporous” means a material, usually a thermoset or thermoplastic polymeric material, preferably a thermoplastic, which is at least about 20 percent by volume, more preferably at least about 35% by volume pores. Often the percentage by volume is higher, for instance about 60% to about 75% by volume pores. The porosity is determined according to the equation:
“Porosity”=100(1−d₁/d₂)
wherein d₁ is the actual density of the porous sample determined by weighing a sample and dividing that weight by the volume of the sample, which is determined from the sample's dimensions. The value d₂ is the “theoretical” density of the sample assuming no voids or pores are present in the sample, and it determined by known calculations employing the amounts and corresponding densities of the samples ingredients. More details on the calculation of the porosity may be found in U.S. Pat. No. 4,892,779, which is hereby incorporated by reference. Preferably the microporous material has interconnecting pores.

The MPS herein may be made by methods described in U.S. Pat. Nos. 3,351,495, 4,698,372, 4,867,881, 4,874,568, and 5,130,342, all of which are hereby included by reference. A preferred microporous sheet is described in U.S. Pat. No. 4,892,779, which is hereby included by reference. Similar to many microporous sheets those of this patent have a high amount of a particulate material (filler). This particular type of sheet is made from polyethylene, much of which is a linear ultrahigh molecular weight polymer.

“Fabric” is a sheet-like material made from fibers. The materials from which the fibers are made may be synthetic (man-made) or natural. The fabric may be a woven fabric, knitted fabric or a nonwoven fabric, and nonwoven fabrics are preferred. Useful materials for the fabrics include cotton, jute, cellulosics, wool, glass fiber, carbon fiber, poly(ethylene terephthalate), polyamides such as nylon-6, nylon-6,6, and aromatic-aliphatic copolyamides, aramids such as poly(p-phenylene terephthalamide), polypropylene, polyethylene, thermotropic liquid crystalline polymer, fluoropolymers and poly(phenylene sulfide).

The fabric herein can be made by any known fabric making technique, such as weaving or knitting. However a preferred fabric type is a NWF. NWFs can be made by methods described in I. Butler, The Nonwoven Fabrics Handbook, Association of the Nonwoven Fabrics Industry, Cary, N.C., 1999, which is hereby included by reference. Useful types of processes for making NWFs for this invention include spun bonded, and melt blown. Typically the fibers in the NWF will be fixed in some relationship to each other. When the NWF is laid down as a molten TP (for example spun bonded) the fibers may not solidify completely before a new fiber layer contacts the previous fiber layer thereby resulting in partial fusing together of the fibers. The fabric may be needled or spun laced to entangle and fix the fibers, or the fibers may be thermally bonded together.

The characteristics of the fabric to some extent determine the characteristics of the bond(s) between the TPs to be joined. Preferably the fabric is not so tightly woven that melted TP has difficulty (under the melt bonding condition used) penetrating into and around the fibers of the fabric. Therefore it may be preferable that the fabric be relatively porous. However, if the fabric is too porous it may form bonds which are too weak. The strength and stiffness of the fabric (and in turn the fibers used in the fabric) may determine to some extent the strength and other properties of the bond(s) formed. Higher strength fibers such as carbon fiber or aramid fibers therefore may be advantageous in some instances.

Without being held to theory, it is believed that the thermoplastic may bond to the surface of the ISS sheet (at least in part) by mechanical locking of the TP to the ISS sheet. It is believed that during the melt bonding step the TP “penetrates” the irregularities on the surface, or actually below or through the surface through pores, voids and/or other channels (if they exist). When the TP solidifies, it is mechanically locked into and/or onto these irregularities and, if present, pores, voids and/or other channels.

One type of preferred material for the TP is a “classical” TP, that is a material that is not easily crosslinkable, and which has a melting point and/or glass transition temperature above about 30° C. Preferably, if such a classical TP is crystalline, it has a crystalline melting point of 50° C. or more, more preferably with a heat of fusion of 2 J/g or more, especially preferably 5 J/g or more. If the TP is glassy it preferably has a glass transition point of 50° C. or more. In some instances the melting point or glass transition temperature may be so high that the TP decomposes before reaching that temperature. Such polymers are also included herein as TPs. Melting points and glass transition temperatures are measured using ASTM Method ASTM D3418-82. The melting point is taken as the peak of the melting endotherm, and the glass transition temperature is taken at the transition midpoint.

Such classical TPs include: poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon-6, nylon-12, nylon-1 1, and aromatic-aliphatic copolyamides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfides such as poly(p-phenylene sulfide); polyetherketones such as poly(ether-ketones), poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); thermoplastic elastomers such as the “block” copolyester from terephthalate, 1,4-butanediol and poly(tetramethyleneether)glycol, and a block polyolefin containing styrene and (hydrogenated) 1,3-butadiene blocks; and chlorinated polymers such as poly(vinyl chloride), vinyl chloride copolymer, and poly(vinylidene chloride). Polymers which may be formed in situ, such as (meth)acrylate ester polymers are also included.

“Thermotropic liquid crystalline polymer” herein means a polymer that is anisotropic when tested using the TOT test or any reasonable variation thereof, as described in U.S. Pat. No. 4,118,372, which is hereby incorporated by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present.

Useful thermosettable (i.e. readily crosslinkable) TPs include epoxy resins, melamine resins, phenolic resins, thermosetting polyurethane resins, and thermosetting polyester resins.

The first article herein may be made from any material, so long as the first surface of the first article does not comprise a resin. That is the first article may comprise a resin, but material that is at the first surface that is bonded with the adhesive does not comprise a resin. Thus the first article (and the first surface) may be (comprise) a metal, ceramic, glass, wood, paper, and paperboard. Preferably the first surface of the first article comprises metal. Metals may include ferrous alloys such as steel, stainless steel, and wrought iron, copper, nickel, aluminum, and alloys of various metals such as Inconel®, and Hastalloy®. Preferred metals are iron and iron alloys.

The steps of bonding the first and second sides of the ISS sheet to the first article and TP, respectively, may be carried out in any order. For example, the second side of the ISS sheet may be melt bonded to the TP, and then the adhesive used to bond the first side of the ISS to the first article. In a preferred procedure the order is reversed, that is the second side of the ISS sheet is bonded to the first article using the adhesive, and then this assembly of the ISS and first article is placed in a mold and the TP is melt bonded to the first side of the ISS.

When using adhesive to bond the first side to the first article the manufacturer's or supplier's recommendations for using that adhesive should be followed. Typically at some point it will involve applying some pressure to the surfaces to be bonded while in contact with the adhesive (either sequentially or simultaneously). The ISS or first article may be contacted first by the adhesive or they may be contacted simultaneously.

The melt bonding may be carried out in a number of ways. For instance, the ISS may be placed against one side of an injection mold and the TP injection molded into the mold. This process may be used with thermally crosslinkable resin(s) and the part held in a hot mold until the(ose) resin(s) crosslink and/or solidify (i.e. thermoset). The ISS may be held in the proper position in the mold by a variety of known techniques such as vacuum, electrostatic charges, mechanically, etc. In another process, a compression mold is filled with the first TP and the ISS is laid on top of the first TP or is against one side of the mold. The mold is closed and heated (or is already hot) and pressure is applied. In all of these processes, the ISS may already be bonded to the first article, so that the assembly of the ISS and first article (and adhesive) are placed in the mold so the TP may be melt bonded to the second side of the ISS.

In another process, a film or sheet of the TP may be placed in contact with the second side an ISS (the ISS may also already be bonded to the first article) and then the assembly placed in a thermoforming machine mold wherein the TP is melt bonded to the ISS, and a thermoformed shaped product is also produced.

In the melt bonding process it is preferred that the rough surface features, whatever they are, of the ISS are not totally destroyed, and are often left fairly intact. For instance if the ISS comprises a TP, and temperature of the melt bonding process results in that TP being melted, the irregularities of the ISS may be lost. This may be avoided by a number of methods. The temperatures needed to cause the TP to melt may be low enough so that the melting point (if any) and/or the glass transition point of any TP comprising the ISS is higher than the melt bonding process temperature. Another method for avoiding loss of surface irregularities is for the ISS to be made from a crosslinked thermoset resin or another material with a high melting point, such as a metal. If the ISS comprises a TP, in some instances the TP may be so viscous that it flows little if at all above the melting/glass transition temperature. The viscosity can be increased by using a large amount filler, and/or using a TP which has a very high molecular weight, such as ultrahigh molecular weight polyethylene. For example, in one type of preferred ISS, preferably MPS, made from a thermoplastic, it is preferred that the thermoplastic have a weight average molecular weight of about 500,000 or more, more preferably about 1,000,000 or more. One useful type of TP which can be obtained in such high molecular weights is polyethylene, and it is a preferred TP for the ISS, preferably MPS. Another method to prevent the loss of rough surface features when bonding (a) TP(s) with higher melting points or glass transition temperatures is to minimize the time of exposure of the ISS to higher temperatures, so that the TP(s) “penetrate” the rough surface in a short period of time, which is not enough time for heat transfer to cause loss of the rough surface. Some of these methods may be combined to further retard loss of surface irregularities in the ISS.

Once the bonded structure is formed, in many instance the bonded interfaces are not the weak point in the structure. That is in many instances attempts to peel the TP from the first article results in cohesive failure of the TP or ISS, illustrating that material's inherent strength is the weak point of the bonded assembly.

The polymers described herein, either the TPs and/or the polymers of the ISS, but particularly the TPs, may contain materials normally found in such polymers, for example, fillers, reinforcing agents, antioxidants, pigments dyes, flame retardants, etc., in the amounts that are normally used in such compositions.

Joined second articles are often useful because they may combine the best attributes of the two TP and first article being combined. For example the TP may contribute one or more of chemical inertness, low friction, abrasion resistance, and toughness, while a first article made for example from metal may contribute strength, stiffness, electrical and/or thermal conductivity, and fatigue resistance. Useful parts for these assemblies include conveyer segments, and housings for electrical or electronic apparatus, structural parts for automotive and none automotive applications, any applications using metal and other materials.

The present process is particularly useful for producing assemblies which have a substantial minimum dimension. By a minimum dimension is meant the smallest dimension of the part that passes through both the thermoplastic and the other material, and typically this may often be referred to as a thickness (not included in this measurement are edges of that part where the thermoplastic and/or other material may taper to a small thickness). Since, for example, in injection molding molten TP comes into contact with the second surface of the ISS, one does not have to rely on heat conduction to cause bonding of the TP to the ISS, and so much thicker parts may be formed. This is in contrast for instance, to roll lamination or lamination in a press, which is typically done with thin cross sections such as films or thin sheets. Preferably a minimum dimension is at least 1 mm, more preferably at least 5 mm and especially preferably at least 10 mm, and very preferably at least about 1.0 cm.

Another dimension is the “maximum bonded thermoplastic dimension”, which is the maximum thermoplastic thickness measured perpendicular to the surface of the other material which is bonded to the first surface of the ISS. Preferably this is at least about 1 mm, more preferably at least about 5 mm, especially preferably at least about 10 mm, and very preferably at least about 1.0 cm.

### EXAMPLES 1-3

In these examples a metal plaque 40×143×3 mm thick was used. Double sided adhesive tape, Scotch® 9473 from 3M Corp. (St. Paul, Minn. 55144, USA), a 250 μm thick acrylic transfer adhesive tape, was applied to one side of the metal plaque and trimmed so that adhesive did not overlap the plaque sides. Before the adhesive tape was applied the surface of the plaque was cleaned with iso-propanol, and the surface slightly abraded with a Scotch-Brite® pad. A precut (to the size of the metal plaque) sheet of MiST® structural bonding film from PPG Corp (Pittsburgh, Pa., USA) was then applied to the other surface of the adhesive tape, so that an assembly of metal plaque, adhesive and then structural bonding film was formed. MiST® film is a microporous ultrahigh molecular weight polyethylene film as generally described in U.S. Pat. No. 4,892,779.

This assembly was then placed in against the side of an injection mold for melt forming polymers. The side having the structural bonding film faced the mold's empty cavity. The shape of the molded was such that a rectangular polymer strip 200×20×3 mm was produced. The strip was longer than the metal plaque and extended over one of the plaque. After closing the mold, Ponaflex® S650A, a styrenic thermoplastic elastomers from Pongs & Zahn AG, Hamburg, Germany, was injected into the mold. The melt temperature of the Ponaflex® S650A was 215° C., the mold temperature was 80° C., the high pressure (inject) time was 18 s, and the cooling time was 10 s. After cooling the mold was opened and the part removed.

After standing for a minimum of 48 h, the adhesion of the Ponaflex® S650A to the metal (through the structural bonding film and adhesive tape) was tested. The plaque was clamping in jig on an extension tester. The plane of the plaque was perpendicular to the axis of extension of the tester. The extended tab of Ponaflex® S650A (only) was clamped in a jaw on the other workpiece of the tester. The Ponaflex® S650A was then pulled away from plaque at right angles to plane of the plaque at a crosshead speed of 100 mm/min. Peeling forces are given in Table 1, and are an average of 3 tests.

TABLE 1

| | | Peeling Force |
|---|---|---|
| Ex. | Metal | (N/cm) |
| 1 | Aluminum | 16.7 |
| 2 | Carbon steel | 15.5 |
| 3 | Stainless steel | 17.5 |

The failure mode for Examples 1-3 was adhesive, that is the failure occurred between the adhesive tape and the structural bonding film. When the Ponaflex® S650A was injection molded directly onto the surface of the metal, the peeling force was zero.

Other thermoplastics, such as an acetal, polyamide or polyester, could be similarly adhered to metal plaques, but many of them were too stiff to be tested and the adhesion quantified in this manner.

It is therefore, apparent that there has been provided in accordance with the present invention, a process for joining thermoplastics to other types of materials that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

It is claimed:

1. A process, comprising:
(a) using an adhesive, bonding a first surface of a first article to a first side of a sheet having said first side and a second side, wherein said first and second sides have irregular surfaces;
(b) melt bonding a thermoplastic to said second side of said sheet, inside a mold;
provided that said first surface of said first article does not comprise a resin; and
producing a second article wherein said first article and said thermoplastic are bonded together.

2. The process as recited in claim 1 wherein said sheet is a nonwoven sheet or a microporous sheet.

3. The process as recited in claim 1 wherein said mold is a mold used in injection molding, compression molding, compression injection molding, thermoforming, or extrusion or injection blow molding.

4. The process as recited in claim 3 wherein said mold is used in injection molding.

5. The process as recited in claim 1 wherein said thermoplastic is a classical thermoplastic.

6. The process as recited in claim 5 wherein said thermoplastic is selected from the group consisting of poly(oxymethylene) and its copolymers, polyesters, polyamides, polyolefins, polystyrene/poly(phenylene oxide) blends, polycarbonates, fluoropolymers, copolymers of ethylene and vinylidene fluoride or vinyl fluoride; polysulfides, polyetherketones, poly(etherimides), acrylonitrile-1,3-butadinene-styrene copolymers, thermoplastic (meth)acrylic polymers, thermoplastic elastomers, and chlorinated polymers.

7. The process as recited in claim 1 wherein said thermoplastic is an uncrosslinked thermosetting resin.

8. The process as recited in claim 1 wherein step (a) is carried out first and then step (b) is carried out.

9. The process as recited in claim 1 wherein step (b) is carried out first and then step (a) is carried out.

10. The process as recited in claim 1 wherein said first surface comprises a metal.
